(19) United States
(12) Patent Application Publication
(10) Pub. No.: US 2013/0311339 A1
(43) Pub. Date: Nov. 21, 2013

(54) CHAT ENABLED ONLINE MARKETPLACE SYSTEMS AND METHODS

(71) Applicant: Leo Jeremias, Los Angeles, CA (US)

(72) Inventor: Leo Jeremias, Los Angeles, CA (US)

(21) Appl. No.: 13/474,633

(22) Filed: May 17, 2012

(51) Int. Cl. G06Q 30/00

(52) U.S. Cl. 705/27.1

(57) ABSTRACT

Embodiments of this disclosure relate to a computer-implemented method including the step of presenting on a graphical user interface reporting search results for a product, information for a plurality of potential vendors of the product. The method further includes presenting, on the graphical user interface, an option to interact with each of a subset of the potential vendors. The method also includes generating an interactive session between the user initiating the search and a selected vendor of the subset of the potential vendors.

### BACKGROUND

The present disclosure generally relates to the field of online marketplaces and search results. Conventional online shopping typically occurs by a user typing a product name or product description into a search engine. The search engine conventionally provides a list of results and the user is required to click into each particular vendor's website to view product offerings and availability. In some cases, the search engine or another aggregation provider can consolidate ratings for merchants and various pricing or availability information relating to particular product numbers. In such examples, the users still must click into the vendor's website to see the real story (e.g., whether the product is still in stock, whether a particular size or color is available, what the actual price is, shipping costs, etc.).

What is needed are systems and methods for facilitating efficient and rich consumer-to-vendor interactions. What is needed is a chat driven online marketplace system.

### SUMMARY

One embodiment relates to a computer-implemented method including the step of presenting, on a graphical user interface reporting search results for a product, information for a plurality of potential vendors of the product. The method further includes presenting, on the graphical user interface, an option to interact with each of a subset of the potential vendors. The method also includes generating an interactive session between the user initiating the search and a selected vendor of the subset of the potential vendors.

Another embodiment relates to a computer system including a processor configured to cause the presentation on a graphical user interface reporting search results for a product, information for a plurality of potential vendors of the product. The processor is further configured to cause the graphical user interface to include an option to interact with each of a subset of the potential vendors. The processor is configured to cause an interactive session to be generated. The interactive session is between the user initiating the search and a selected vendor of the subset of the potential vendors.

The processor may provide the interactive session without requiring the user to browse away from the report of search results. The interactive session may be provided in a window in the graphical user interface of reported search results. The graphical user interface may be a web page. The interactive session may be provided within a new pop-up window over the graphical user interface of reported search results. The processor may be configured to recall contact information for the vendor and to establish an on-demand communication link with a computing device of the vendor for conducting the interactive session. The on-demand nature of the communication link and the format of the vendor's computing device communication may be normalized prior to presentation to the user in the interactive session. The option to interact may be presented as at least one of a link, a button, and a text box on the graphical user interface. The option to interact may be presented on the graphical user interface adjacent a graphical preview of the vendor's website. The processor may further be configured to present an option, on the graphical user interface reporting search results, for allowing simultaneous selection of more than one vendor for the interactive session. The processor may also be configured to, in response to the selection of the more than one vendor for the interactive session, cause the interactive session to be between the user and the more than one selected vendors in a single interactive session room. The chat may be a text chat and wherein a link for purchasing the product from the vendor is caused to be shown in the text chat. In other embodiments, the established chat may be accompanied by or replaced by a voice-over-IP session.

Another embodiment relates to a non-transitory computer readable medium. The non-transitory computer readable medium includes computer code for execution by a computer system including at least one processor. The computer code configures the computer system to complete a process including receiving a search parameter relating to a product. The process further includes using the search parameter to generate a graphical user interface including a list of search results. The search results include links to a plurality of potential vendors of the product. The process further includes presenting, for at least a subset of the links to the plurality of potential vendors, an option for interacting with a representative from each vendor. The process yet further includes receiving user interface feedback representing a request to initiate an interactive session with a selected vendor. The process also includes presenting an interactive session with the selected vendor in response to the received user interface feedback.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, wherein like reference numerals refer to like elements, in which:

FIG. 1A is a block diagram of an online marketplace system, according to an exemplary embodiment;

FIG. 1B is a block diagram of an online marketplace system, according to another exemplary embodiment;

FIG. 1C is a block diagram of an online marketplace system, according to another exemplary embodiment;

FIG. 1D is a block diagram of an online marketplace system, according to another exemplary embodiment;

FIG. 2 is a more detailed block diagram of the client and vendor of the online marketplace system of FIGS. 1A-D, according to an exemplary embodiment;

FIG. 3 is a detailed block diagram of the marketplace server of the online marketplace system of FIGS. 1A-D, according to an exemplary embodiment;

FIG. 4A is a detailed block diagram of the search engine module of the marketplace server of FIG. 3, according to an exemplary embodiment;

FIG. 4B is a detailed block diagram of the vendor account module of the marketplace server of FIG. 3, according to an exemplary embodiment;

FIG. 5 is an example graphical user interface for displaying search results for the online marketplace system, according to an exemplary embodiment;

FIG. 6 is an example graphical user interface for providing a chat interface for the online marketplace system, according to an exemplary embodiment;

FIG. 7 is an example graphical user interface for providing a bidding interface for the online marketplace system, according to an exemplary embodiment;

FIG. 8 is an example graphical user interface for providing a feedback interface for the online marketplace system, according to an exemplary embodiment;

FIG. 9 is a flow chart of a process for providing search results to a user of the online marketplace system, according to an exemplary embodiment;

FIG. 10 is a flow chart of a process for providing a chat interface to a user and vendors of the online marketplace system, according to an exemplary embodiment;

FIG. 11 is a flow chart of a process for providing a bidding interface to a user and vendors of the online marketplace system, according to an exemplary embodiment;

FIG. 12 is a flow chart of a process for providing search results to a user of the online marketplace system, according to another exemplary embodiment;

FIG. 13 is a flow chart of a process for providing a bidding interface in response to a user offer to a user and vendors of the online marketplace system, according to an exemplary embodiment; and

FIG. 14 is a flow chart of a process for offer authorization of the online marketplace system, according to an exemplary embodiment.

### DETAILED DESCRIPTION OF THE EXEMPLARY EMBODIMENTS

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

Referring generally to the figures, systems and methods for providing an online marketplace to a user and vendors is described. A user may use the online marketplace system to search for products and services, to chat with vendors providing the products and services, and to purchase the products and services. The user may first provide a search query to a search engine via an interface (e.g., via an app on a mobile device, via a browser on a computer, etc.). After the user receives the search results, the user may select one or more results or vendors associated with the results. The user can then chat with the selected vendor without requiring the user to browse to the vendor's website. For example, the search results page itself or a plug-in on top of the search page may allow the user to initiate the chat. Systems or methods constructed or provided according to some embodiments of the present disclosure advantageously permit the user to rapidly obtain person-to-person feedback without requiring the user to visit website pages for each vendor in a serial manner.

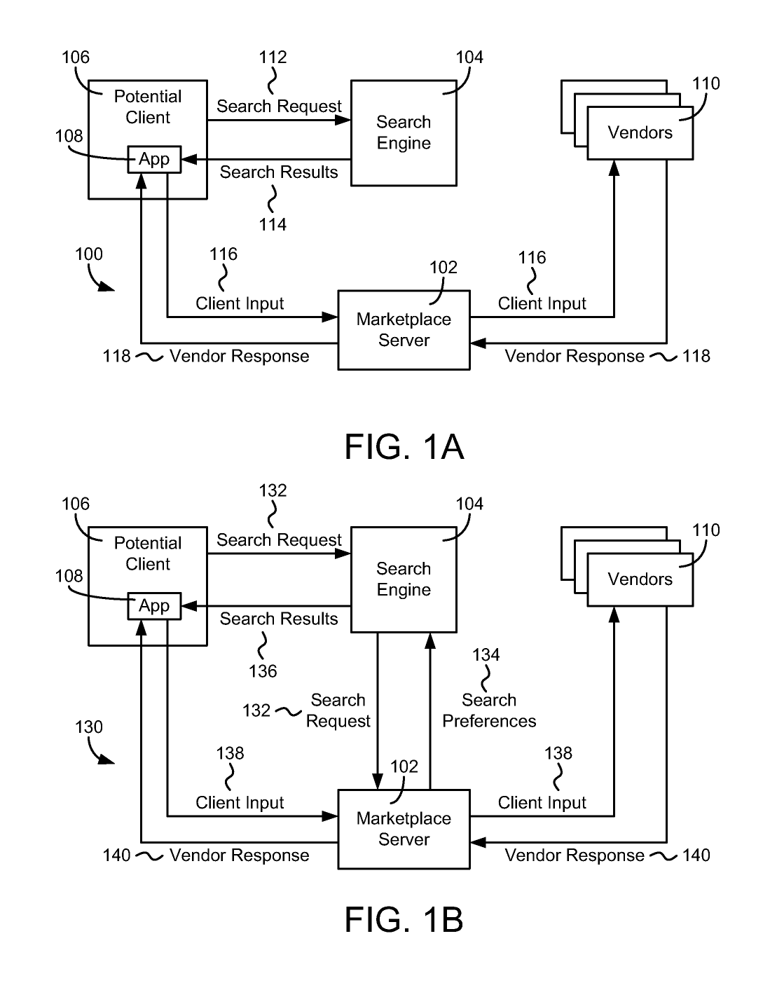

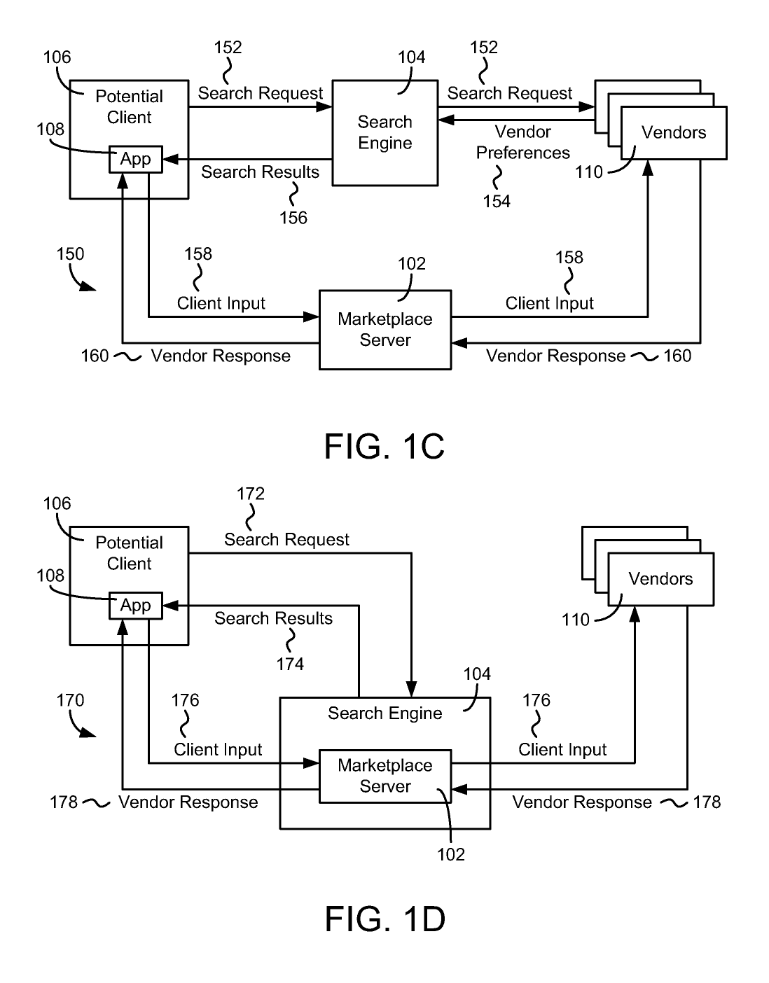

Referring to FIGS. 1A-D, online marketplace systems are shown, according to various exemplary embodiments. Online marketplace systems 100, 130, 150, 170 of FIGS. 1A-D generally include a marketplace server 102, search engine 104, a potential client 106, and vendors 110. Potential client 106 may provide a search request to search engine 104 and receive search results from search engine 104. Search engine 104 may be a single search engine, more than one search engine, or a search engine that aggregates search results from multiple other search engines. Potential client 106 may be connected to marketplace server 102. Marketplace server 102 may receive search results, client input, and other information from potential client 106. Marketplace server 102 may then provide the input to the one or more vendors 110 and provide a response from vendors 110 to potential client 106. In other words, marketplace server 102 is configured to facilitate interaction, such as a chat, between potential client 106 and vendors 110. The interaction between potential client 106, vendors 110, marketplace server 102, and search engine 104 may vary as shown in FIGS. 1A-D or otherwise. In varying embodiments, an interactive session may be a chat session (e.g., SMS, instant messaging, texting, etc.), a voice over-IP session, a Skype session, a video conference session, or another interactive computer-based communication session.

Referring now to FIG. 1A, one exemplary configuration of online marketplace system 100 is shown. Online marketplace system 100 includes a marketplace server 102, search engine 104, a potential client 106, and one or more vendors 110. Marketplace server 102 may be configured to manage interaction between client 106 and vendors 110. In the embodiment of FIG. 1A, potential client 106 may provide a search request 112 to search engine 104, and receives search results 114. Potential client 106 may view the search results via application 108 (e.g., an application on a mobile device, a browser on a computer or laptop, etc.). In the embodiment of FIG. 1A, the activity of search engine 104 is shown independent of marketplace server 102 activity. In such an embodiment, marketplace server 102 may be configured to manage interaction between potential client 106 and vendors 110 without directly communicating with the search engine that potential client 106 uses to select vendors 110. The embodiment of FIG. 1A may operate with the assistance of application 108 (e.g., browser plug-in) that parses search results for facilitating the chat-based marketplace activity.

The user may select one or more search results or vendors associated with the search results using application 108. The selections and other client input 116 may be provided to marketplace server 102. Marketplace server 102 may use the selection of the search results and vendors to contact the vendors (e.g., to establish an on-demand chat session). Marketplace server 102 may provide the client input 116 (e.g., input chat text) to vendors 110 and may provide vendor responses 118 (e.g., chat responses, acceptance of the chat session, etc.) to client 106 (e.g., via app 108). For example, if client input 116 indicates that potential client 106 is interested in a product of a vendor 110, vendor 110 may receive client input 116 and indicate via vendor response 118 whether the vendor is available to chat with potential client 106. As another example, if client input 116 indicates that potential client 106 is interested in receiving an offer from vendor 110, vendor 110 may receive client input 116 and indicate whether the vendor can provide an offer. The vendor may provide the offer as part of a vendor response 118 to potential client 106 via marketplace server 102.

Vendors 110 may provide vendor information to marketplace server 102. Online marketplace system 100 may be a subscription-based system and marketplace server 102 may use information received from the vendor to authenticate a vendor 110. Marketplace server 102 may further charge vendors 110 for participating in the online marketplace system, allow vendors to provide preferences relating to the display of search results related to vendors 110, and otherwise manage vendor 110 usage of the online marketplace system.

Referring now to FIG. 1B, another exemplary configuration of an online marketplace system 130 is shown, according to an exemplary embodiment. After potential client 106 provides a search request 132 to search engine 104, marketplace server 102 may receive search request 132. Marketplace server 102 may then provide search preferences 134 to search engine 104 which may be used by search engine 104 to determine which search results 136 to provide to potential client 106. For example, search preferences 134 may include a preferred vendor. If a vendor 110 has subscribed to the online marketplace system, search results associated with the vendor may be listed at the top of search results 136. As another example, search preferences 134 may include vendors that are participating in the online marketplace system. Search engine 104 may use the list of vendors to determine which search results to provide to potential client 106. In other words, search results 136 provided to potential client 106 are impacted by the activity of marketplace server 102, which works in conjunction with search engine 104. Potential client 106 may then view search results 136 via application 108. Client input 138 may be provided to vendors 110 via marketplace server 102, and the vendor response 140 may be provided to potential client 106 by marketplace server 102, as described above, to initiate a chatting or bidding process between client 106 and vendors 110. For example, client input 138 may include a client question or comment posted in the chat interface, and vendor response 140 may include a response to the client question or comment. Marketplace server 102 may facilitate continuous communication between client 106 and vendors 110.

Referring now to FIG. 1C, another configuration of an online marketplace system 150 is shown, according to an exemplary embodiment. After potential client 106 provides a search request 152 to search engine 104, vendors 110 may receive the search request. Vendors 110 may provide vendor preferences 154 to search engine 104, and search engine 104 may use vendor preferences 154 to determine which search results 156 to provide to potential client 106. Vendor preferences 154 may include if the vendor is a preferred vendor (e.g., a vendor whose search results affiliated with the vendor are shown at the top of the search results), if the vendor is a participant in the online marketing system, if the vendor is available to chat with client 106, etc. Search results 156 may be sorted based on vendor preferences 154. Potential client 106 may then view search results 156 via application 108. In other words, search results 156 provided to potential client 106 are impacted by vendor preferences related to the online marketplace system described in the present disclosure. Client input 158 may be provided to vendors 110 via marketplace server 102, and the vendor response 160 may be provided to potential client 106 by marketplace server 102, as described above, to initiate a chatting or bidding process between client 106 and vendors 110. For example, client input 158 may include a client question or comment posted in the chat interface, and vendor response 160 may include a response to the client question or comment. Marketplace server 102 may facilitate continuous communication between client 106 and vendors 110.

Referring now to FIG. 1D, another configuration of an online marketplace system 170 is shown, according to an exemplary embodiment. In the embodiment of FIG. 1D, search engine 104 is shown to include marketplace server 102. Search engine 104 may include marketplace server 102 in the process of finding and delivering search results to potential client 106. In other words, marketplace server 102 is a search engine itself or functions with search engine 104 as a search engine independent of all other search engines. Search engine 104 uses results and information from marketplace server 102 to provide search results 174 to client 106 without using information from other search engines. In the embodiment of FIG. 1D, marketplace server 102 uses information related to the vendors subscribed or affiliated with marketplace server 102 and the products and services the vendors provide to determine appropriate search results 174 for a given search request 172. In such an embodiment, marketplace server 102 may include one or more modules for comparing search request 172 to vendors and vendor offers to determine appropriate search results 174.

Search engine 104, upon receiving a search request 172 from potential client 106, provides the request to marketplace server 102. Marketplace server 102 may determine which search results to provide or highlight compared to other search results. Potential client 106 may then receive search results 174 and view search results 174 via application 108. Client input 176 may be provided to vendors 110 via marketplace server 102, and the vendor response 178 may be provided to potential client 106 by marketplace server 102, as described above, to initiate a chatting or bidding process between client 106 and vendors 110. For example, client input 176 may include a client question or comment posted in the chat interface, and vendor response 178 may include a response to the client question or comment. Marketplace server 102 may facilitate continuous communication between client 106 and vendors 110.

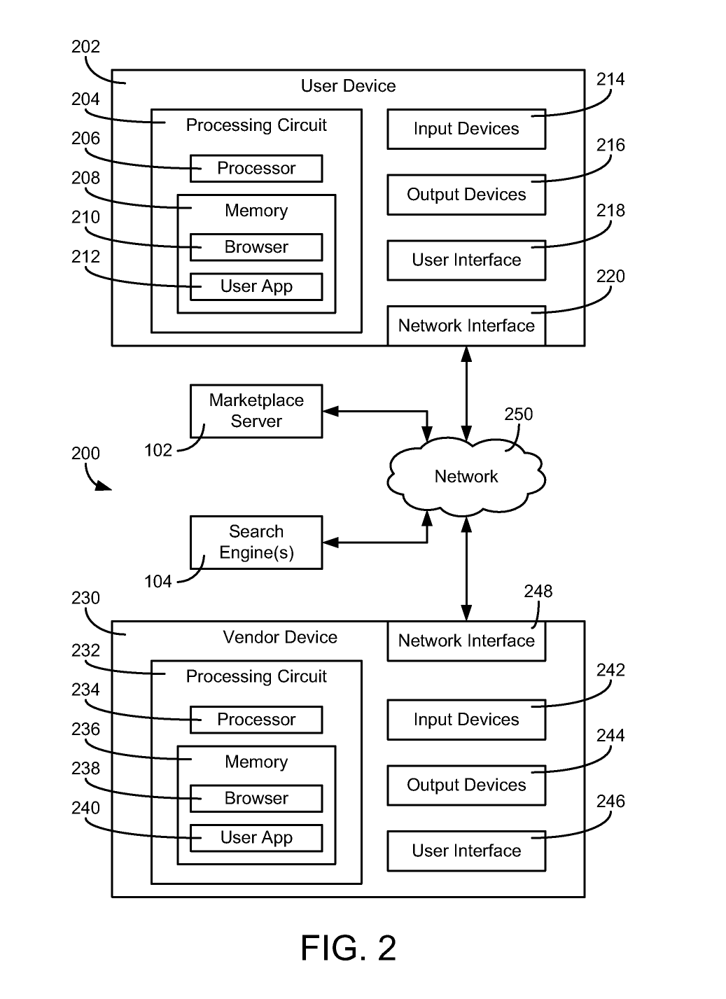

Referring now to FIG. 2, a user device 202 and vendor device 230 for potential client 106 and vendors 110 are shown, according to an exemplary embodiment. Clients and vendors may be connected to marketplace server 102 and search engines 104 via network 250. Clients and vendors may use user device 202 and vendor device 230 to access the online marketplace system described herein (e.g., the online marketplace system of FIGS. 1A-D, referred to collectively as online marketplace system 200 in FIG. 2).

Online marketplace system 200 includes a user device 202. User device 202 may be, for example, a computer, laptop, mobile phone, PDA, or other computing device that provides information to the client or user of user device 202 relating to online marketplace system 200. The user may view search results, select search results and vendors, converse with vendors, and select offers for purchase using user device 202.

User device 202 includes a processing circuit 204 including a processor 206 and memory 208 for completing the various user or client processes of the present disclosure. Processor 206 may be implemented as a general purpose processor, an application specific integrated circuit (ASIC), one or more field programmable gate arrays (FPGAs), a group of processing components, or other suitable electronic processing components. Memory 208 may be one or more devices (e.g., RAM, ROM, flash memory, hard disk storage, etc.) for storing data and/or computer code for completing and/or facilitating the various user or client processes, layers, and modules described in the present disclosure. Memory 208 may be a non-transitory medium or include volatile memory or non-volatile memory. Memory 208 may include database components, object code components, script components, or any other type of information structure for supporting the various activities and information structures of the present disclosure. Memory 208 may be communicably connected to processor 206 and includes computer code or instructions for executing one or more processes described herein.

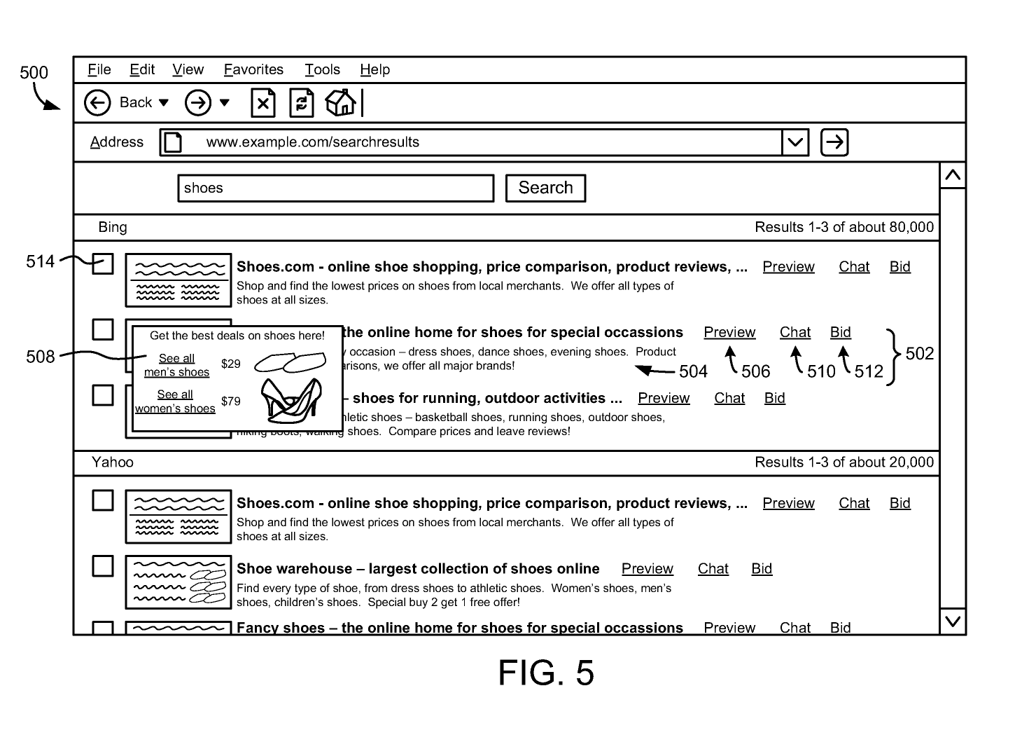

Memory 208 is shown to include a browser module 210 and user app module 212. Browser module 210 may be configured to provide a software application for viewing search results and interacting with a chat interface and bidding interface. Browser module 210 may be used with the user is accessing system 200 on a laptop, desktop, or a mobile device that does not have or support a particular app for interfacing with system 200. User app module 212 may similarly provide an application for viewing search results and interacting with a chat interface and bidding interface. User app module 212 is configured to provide an application on, for example, a mobile phone or other handheld device. Memory 208 may include only one of browser module 210 and user app module 212, or may include both. As examples, the embodiments shown in FIGS. 5-8 are examples of applications provided by browser module 210. In various embodiments, elements of the screenshots of FIGS. 5-8 may be shown on either type of client (e.g., a browser-based client or an application-based client).

User device 202 further includes network interface 220. Network interface 220 may be configured to communicate with marketplace server 102 and search engines 104 via one or more networks 250 (e.g., a mobile phone network, the Internet, etc.). Input devices 214 may include any input device (e.g., keyboard, mouse, phone keypad, touchscreen, etc.) that may be used by a user of device 202 to interact with marketplace server 102 and vendor device 230. Output devices 216 may include display screens, monitors, speakers, and/or other visual and audio components for providing a user of device 202 with vendor information and search result information. User interface 218 can be any control, pointer, keypad, sensor, or sensors configured to accept user input relating to interaction between the user and vendor. It should be appreciated that some user devices 202 (e.g., full computers) will include many input devices 214, output devices 216, or user interfaces 218 while other user devices 202 (e.g., a touchscreen-based mobile phone) will primarily have a single touchscreen display for all user input/output activities.

Vendor device 230 may be, for example, a computer, laptop, mobile phone, PDA, or other computing device that provides the vendor access to the online marketplace system. The vendor may receive information relating to clients interested in the vendor, and the vendor may interact with the clients using vendor device 230. Vendor device 230 includes a processing circuit 232 including a processor 234 and memory 236. Processing circuit 232, processor 234, and memory 236 may have the same functionality as described with reference to processing circuit 204, processor 206, and memory 208. Memory 236 includes browser module 238 and user app module 240 that provides an application that allows the vendor to view client information (e.g., if a client is interested in a product or service of the vendor) and to converse with the client (e.g., chatting with the client or providing an offer to the client). Vendor device 230 further includes input devices 242, output devices 244, user interface 246, and network interface 248. Components 242-248 may have the same functionality as described with reference to components 214-220 of user device 202.

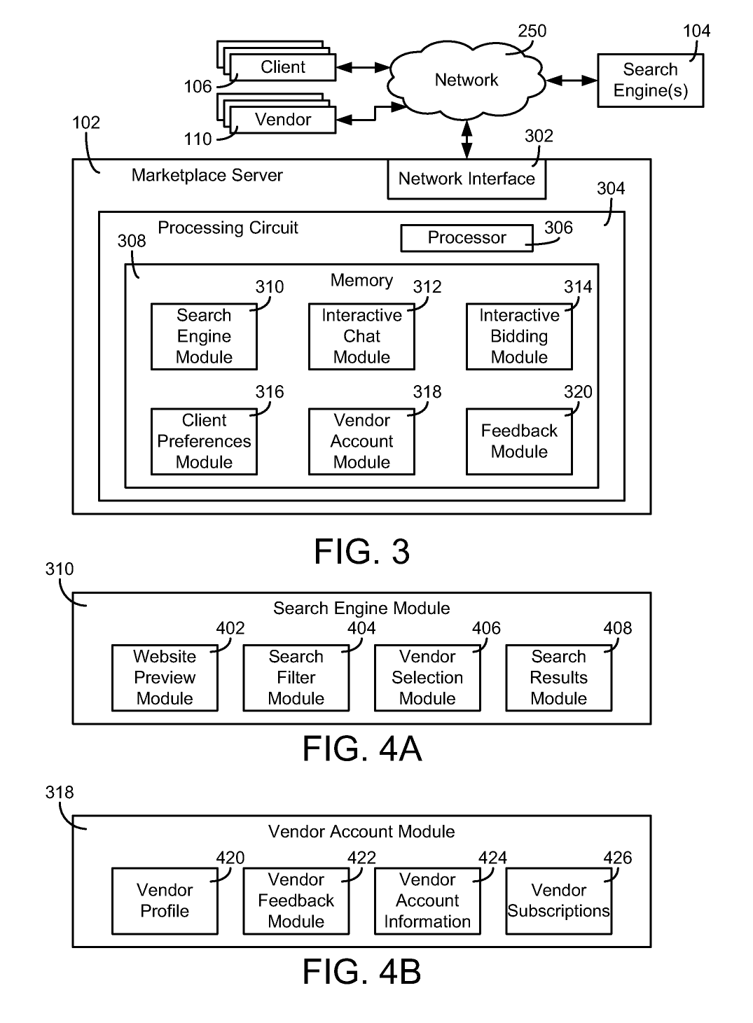

Referring now to FIG. 3, marketplace server 102 is shown in greater detail. Marketplace server 102 may be connected to search engines 104, clients 106, and vendors 110 via network interface 302 and network 250. Network interface 302 may be configured to communicate (e.g., wirelessly or non-wirelessly) with search engines 104, clients 106, and vendors 110 via network 250. Marketplace server 102 including a processing circuit 304 including a processor 306 and memory 308. Processing circuit 304, processor 306, and memory 308 may be configured as described above with reference to the processing circuits, processors, and memory of FIG. 2.

Memory 308 includes various modules for completing the processes described herein. Memory 308 includes a search engine module 310 configured to receive search results and other information from a search engine or other source and format the search results for the clients. Memory 308 further includes an interactive chat module 312 configured to manage a chat interface that a client and one or more vendors may use to communicate with one another. Memory 308 further includes an interactive bidding module 314 configured to manage an interface that allows vendors to submit bids to a client and clients to select bids for purchase. Memory 308 further includes a client preferences module 316 and vendor account module 318 configured to manage client and vendor interaction with marketplace server 102. Memory 308 further includes feedback module 320 configured to manage vendor feedback provided by clients.

Referring also to FIG. 4A, the activities of search engine module 310 are shown in greater detail. Search engine module 310 may be configured to receive search results and other information from a search engine or client device. Search engine module 310 may then format the search results for the client and provide the formatted search results to the client for display (e.g., on browser module 210 or user app module 212). Search engine module 310 may further manage client interaction with the search results by providing links to preview images for the websites and chat windows for interaction between the client and vendors. Search engine module 310 includes a website preview module 402, search filter module 404, vendor selection module 406, and search results module 408 for formatting the search results for the client.

In the embodiments of FIGS. 3 and 4A, search engine module 310 is shown as part of marketplace server 102. In other embodiments, some or all of the functionality provided by search engine module 310 may be executed on a browser module or user app module of a client device as shown in FIG. 2, may be executed by a search engine 104 configured to receive a search request from a client, or otherwise. For example, search engine module 310 may provide instructions to a browser module or user app module of a client device that allows the client device to incorporate the features described herein on the client device (e.g., handling activity on the client side instead of the server side, allowing images, links, and other information to load faster). The instructions may be implemented by, for example, a browser add-on application that is installed on the client device.

Further, search engine module 310 may be a part of marketplace server 102 or another module. For example, in the embodiment of online marketplace system 170 of FIG. 1D, search engine module 310 may be a module within marketplace server 102 and search engine 104. As another example, in the embodiment of online marketplace system 130 of FIG. 1B, search engine module 310 receives search results before client 106 does, and formats the search results before they are received by client 106.

In another embodiment, search engine module 310 may be configured to determine search results for a given search request. For example, with reference to online marketplace system 170 of FIG. 1D, marketplace server 102 may be configured to generate search results for a search request. Search engine module 310 may receive the search request and determine the most relevant search results, based on the vendors or vendor offers and the search terms or keywords of the search request.

Website preview module 402 may be configured to generate a preview of a website associated with a search result. Upon receiving search results, website preview module 402 may generate a preview image of the website associated with each search result. In one embodiment, the preview image may be a cached thumbnail image of the website, making it easier for the client browsing the search results to see the contents of the website without clicking on any link. The client may select to view the preview image when the client is presented with the search results. In one embodiment, a link may be provided that the client may select to view the preview image. In another embodiment, the client may simply scroll a mouse over a link to pull up the preview image. In yet another embodiment, the client may scroll a mouse over the link to pull up the preview image, and then select a preview link to update the preview image.

Search filter module 404 may be configured to filter the received search results by removing duplicated search results, highlighting particular search results, and otherwise determining which search results to show. For example, when a client provides a search request to a search engine, results from multiple search engines may be returned to the client. Search filter module 404 may be configured to remove duplicated search results, e.g., search results that were found by two or more search engines. Search filter module 404 may further change the order of search result listings. For example, if a search result is associated with a “preferred” vendor or other vendor that has a subscription with marketplace server 102, then search filter module 404 may list the search result at the top of all search results, highlight the search result, or make any other stylistic change.

Vendor selection module 406 may be configured to manage user selections of vendors from the search results. For example, after being provided with search results, the client may select one or more vendors to participate in a chatting process or bidding process. Vendor selection module 406 may receive the selection of the one or more vendors and may be configured to invite the vendors to reply to the client via the chat interface, or to submit bids via the bidding interface. In one embodiment, for each search result, the client may be provided a link that allows the client to select the vendor. Upon selection of the link, a chat interface may be provided to the client, and a chat interface may simultaneously be provided to a vendor, allowing the client and vendor to chat in one embodiment. In another embodiment, a checkbox or other button may be provided for each search result, and the client may select the search result via the checkbox in order to select one or more vendors to chat with or to receive an offer from. The client may be able to select one vendor at a time or multiple vendors at the same time, for either a chatting or a bidding process (e.g., selecting multiple vendors to chat with at the same time, selecting multiple vendors to invite to a bidding process, etc.).

Search results module 408 may be configured to format each search result for the client. For example, for each search result, search results module 408 may generate links the client may click on. A link may take the client to a preview of the website, may open a chat window that allows the client to chat with the vendor (as described with reference to vendor selection module 406), may open a bidding window that allows vendors to submit bids to the client, etc. Search results module 408 may further determine which content is displayed for each search result (e.g., the short description of the search result or vendor, which links or preview images to include). In other words, search results module 408 uses the information from modules 402-406 and other information to generate a search result listing for the client.

The search results may be presented in various ways. For example, module 408 may be configured to provide text search results (e.g., a title and description for each search result). As another example, module 408 may generate visual search results. The search results may be icon based (e.g., each search result is represented by an icon), window based (e.g., each search result is represented by a window showing a website's homepage and other information), may be 3D (a three-dimensional representation of the search results), or may be based on the type of search the client is requesting. For example, if the client is searching for blogs, a tiled 3D view may be used to display the search results, allowing the client to scroll through screenshots of websites associated with the search results. Search results module 408 may be configured to determine a type of presentation for the search results and to provide the client device receiving the search results with the presentation.

Interactive chat module 312 may be configured to manage a chat interface between a client and one or more vendors. Interactive chat module 312 may receive an indication from a client that the client wishes to initiate a chat with one or more vendors. The indication may come from a client clicking a chat link provided with a search result, according to one embodiment. After receiving the indication, a chat window may be provided on the website the client is viewing. The process of displaying the chat window for the client may vary, according to various embodiments. The chat interface may be provided on the same website the client is browsing the search results on or the chat window may be loaded for the client on a new website. As an example, a chat window may pop up on the current webpage the client is browsing. As another example, the chat window may pop up on the current webpage the client is browsing, but only after the vendor has responded and provided an initial message. As yet another example, a chat window may be part of the loaded webpage, and upon selection of a link, all future client and vendor interaction may occur in the chat window (e.g., the chat window may be loaded as an empty window on, for example, the right side of the screen, and future chat interaction may be displayed in the window). As yet another example, upon a selection of the chat link, a chat interface may be opened on the webpage directly below the corresponding search result, pushing other search results down the page.

The client may then use the chat interface to type a question or other response for the vendor, and the vendor response may be posted in the chat window as well. In other embodiments, other methods for inputting a question for the vendor or receiving a vendor response may be implemented (e.g., voice input/output). For example, the chat interface may be integrated with voice over IP (VoIP) technology that allows the client and vendors to speak to each other. As another example, while the chat interface is open, the client may call the vendor using a software application (e.g., Skype) to further discuss the product or service with the vendor. In general, this allows the client and a vendor to conduct a conversation regarding a product or service associated with the vendor and the selected search result. A chat interface may be initiated for the client for each vendor, or a chat interface may host a conversation between a client and multiple vendors.

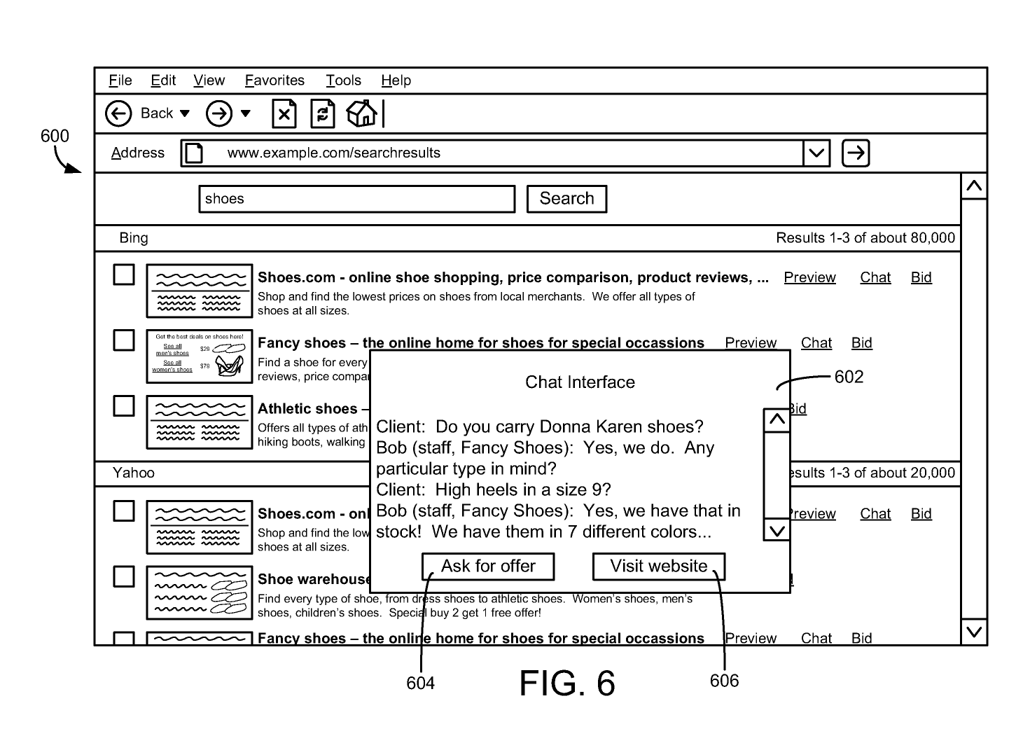

Interactive chat module 312 may be configured to contact the one or more vendors the client is interested in and to provide a chat interface to the vendors. For both the clients and vendors, interactive chat module 312 may be configured to provide the chat interface for various types of devices. Interactive chat module 312 may provide a chat interface for a computer, laptop, smartphone, or other mobile device. Interactive chat module 312 may integrate with various software applications (e.g., Skype), allowing a client or vendor to communicate via the chat interface through the software application. The activities of interactive chat module 312 is described in greater detail with reference to FIG. 6.

Interactive chat module 312 (or another module of marketplace server 102) may further be configured to filter chat interaction between the client and the one or more vendors. Interactive chat module 312 may detect when a vendor is “spamming” the chat window of the chat interface with messages, when a vendor or client is providing inappropriate content, when a vendor is being disruptive, or otherwise. For example, if during a chat, the vendor is spamming the chat window with messages not related to a client query (e.g., a “BUY NOW!!!!” message repeated multiple times without addressing a client question or comment, posting a detailed offer multiple times without addressing a client question or comment, etc.), interactive chat module 312 may terminate the chat (or remove the offending vendor from the chat) or alert the client that the vendor is not cooperating with the chatting system. As another example, if the vendor is providing inappropriate content (e.g., content not related to the search result or a client question or comment) or if the vendor or client is being disruptive (e.g., using foul language), interactive chat module 312 may terminate the chat or alert the client or vendor that the other party in the chat is being inappropriate.

Interactive bidding module 314 may be configured to manage a bidding process between a client and one or more vendors. Interactive bidding module 314 may receive an indication from a client that the client wishes to receive bids for a product or service from one or more vendors. The client may select all vendors related to the received search results or may select particular vendors and search results. Interactive bidding module 314 may be configured to contact the one or more vendors the client is interested in and to provide a bidding interface to both the client and vendors. The bidding interface may be configured to allow vendors to submit bids and other comments, and allow the client to reject or accept a bid, in addition to posting other comments. Interactive bidding module 314 may receive an indication of an accepted bid and manage the interaction between the client and the vendor of the accepted bid.

As an example of an interaction between a client and vendors via the bidding interface, the client may first invite one or more vendors into the chat window or bidding window. The client may individually select vendors, may choose to select all vendors associated with the first ten or twenty search results, may choose the vendors based on a list of criteria provided by the client to the marketplace server, or may select the vendors in any other way. The client may then provide a product or service (e.g., pair of shoes) that the client wishes to purchase. The vendors may then provide offers (e.g., a vendor may offer a pair of shoes for $40, another vendor then offers the same pair of shoes for $35, and so forth), and other comments, via the bidding interface. The offers may simply include a cost for the offer, or may include additional terms (e.g., free shipping, money-back guarantees, etc.). These additional terms may be provided as a comment by the vendor or integrated with the rest of the offer (e.g., the cost and product). The bidding interface may be configured to present the offer in various formats. For example, the offer may be provided such that if a client clicks on the offer in the bidding interface, the offer is accepted, or the client may click the offer to then choose whether to accept or reject the offer.

As another example of an interaction between a client and vendors via the bidding interface, the client may view a search result for a particular vendor. The client may then choose to provide an offer to the vendor for a product or service. For example, the client may view the search results for a vendor that sells shoes, and the client may provide an offer of $40 for a particular pair of shoes. The client may type out the offer; or one or more links, drop-down boxes, or checkboxes may be provided with the search results that allow the client to select a price or price range, along with a particular brand or type of shoe. After providing the offer to the vendor, the vendor may choose to accept, reject, or counteroffer the offer. Interactive bidding module 314 may then provide a bidding interface to allow the vendor and client to interact with one another, with the initial client offer triggering the bidding process.

The client may review the bids, offers, and comments and may select an offer to accept (e.g., selecting the offer for the $35 pair of shoes). Interactive bidding module 314 may then provide the client and vendor a way to finalize the offer. For example, interactive bidding module 314 may provide a chat interface to the client and vendor of the winning offer to finalize the deal, may boot all non-winning vendors from the bidding interface and allow the client and vendor to chat, etc. Interactive bidding module 314 may then finalize the deal, or the deal may be finalized independently by the client and vendor. In addition to accepting an offer, the client may further boot vendors out of the bidding interface (e.g., vendors with inadequate offers or offers not relevant to the client), invite other vendors to the bidding interface, reject offers, provide reasons for rejections (e.g., the price of the pair of shoes in an offer being too high), or provide further details to the vendors.

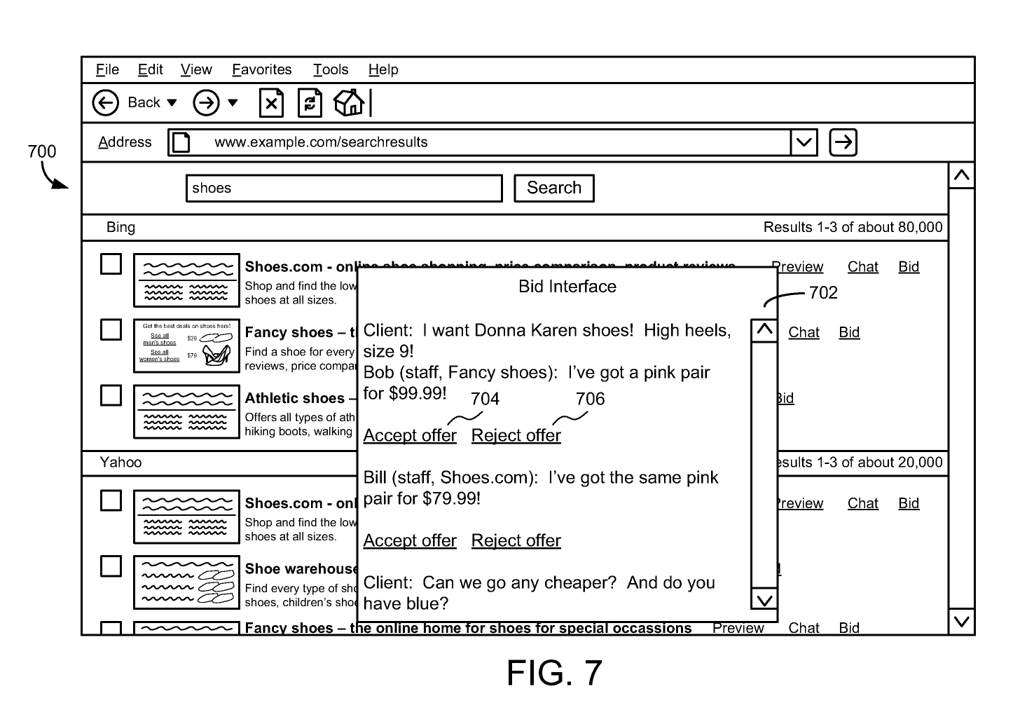

In one embodiment, the bidding interface may be an interface integrated with the chat interface. For example, the client may first initiate a chat with the one or more vendors, then select to start a bidding process with the vendors. The chat interface may then be adjusted to allow offers to be submitted, accepted, and rejected. In another embodiment, upon starting a bidding process, a new bidding interface may be launched independently of the chat interface. The chat interface and bidding interface may be independent interfaces or may be integrated in various ways without departing from the scope of the present disclosure. Further, the bidding interface may be displayed in any manner as described with respect to interactive chat module 312. The activities of interactive bidding module 314 is described in greater detail with reference to FIG. 7.

Like interactive chat module 312, interactive bidding module 314 (or another module of marketplace server 102) may further be configured to filter interaction between the client and the one or more vendors in the bidding process. Interactive chat module 312 may detect when a vendor is “spamming” the bidding window of the bidding interface with offers and messages, when a vendor or client is providing inappropriate content, when a vendor is being disruptive, or otherwise. For example, if during a bidding process, the vendor is spamming the bidding window with the same offer over and over again (e.g., providing the same offer over and over that a client has already rejected), interactive bidding module 314 may remove the vendor from the bidding window and alert the client of the removal.

Client account module 316 may be configured to manage client interaction with marketplace server 102. Marketplace server 102 may provide a chat and bidding interface as described with reference to modules 312, 314, and client account module 316 may be configured to track client usage of the chat interface and bidding interface or may track client history relating to interaction with the search results. For example, client account module 316 may manage customer account information or may use customer feedback to adjust the search results (e.g., putting preferred vendors' search results at the top, using bad feedback to remove other vendors' search results). Further, client account module 316 may be configured to manage post-purchase activities. For example, upon purchasing an offer, client account module 316 may be configured to hold client funds in escrow for the vendor, may authorize the client for purchase of the offer, may verify terms and conditions of the offer with the client, or otherwise. Post-purchase activities of the client and marketplace server 102 are described in greater detail with reference to FIG. 14.

Referring now to FIG. 4B, the activities of vendor account module 318 are shown in greater detail. Vendor account module 318 is configured to manage vendor interaction with marketplace server 102. Vendor account module 318 may include a vendor profile module 420. Vendor profile module 420 may include information relating to the vendor such as the vendor name, products and services offered by the vendor, a vendor interaction history with the marketplace server (e.g., the number of times a vendor has sold an offer to a client or chatted with a client, etc.), and other vendor information. Vendor profile module 420 may be configured to provide vendor information to a client as part of the search results, as part of the chat interface or bidding interface, or otherwise.

Vendor profile 420 may include information about the specific offers provided by the vendor. For example, in one embodiment, the online marketplace system of the present disclosure may allow clients to provide a bid on an offer (e.g., a price). Vendor profile 420 may include information about specific products and services provided, along with any other options. For example, if the vendor sells shoes, vendor profile 420 may include a list of brands of shoes offered, options for the shoes like shoe size and shoe color, and other information. Vendor profile 420 information may then be provided to the client such that the client can provide a specific offer to the vendor.

Vendor account module 318 further includes vendor feedback module 422. Vendor feedback module 422 is configured to track feedback provided by clients for each vendor. After a client provides vendor feedback (see feedback module 320 of FIG. 3), vendor feedback module 422 may store and organize the vendor feedback. The vendor feedback may then be provided to a client in a subsequent search. In various embodiments, the vendor feedback may be provided upon client request, or may be provided as part of the search results.

Vendor account module 318 further includes vendor account information 424. Vendor account information 424 may include vendor information related to the use of marketplace server 102. For example, vendor account information 424 may include vendor preference information such as a preferred preview image, preview image presentation, or vendor description. Vendor account information 424 may be displayed to a client in various ways. For example, vendor account information may be included in the display with a chat interface or bidding interface, so that the client may view the vendor account information without looking away from the chat interface or bidding interface.

Vendor account module 318 further includes vendor subscriptions 426. A vendor may subscribe to marketplace server 102, according to an exemplary embodiment. The vendor subscription may allow the vendor's search results to receive preferential treatment, may allow the vendor a better chance to chat with and provide offers to clients compared to other vendors, etc. For example, if a vendor subscribes to marketplace server 102, the search results related to the vendor may be given priority compared to other search results (the search results may be highlighted or listed at the top of the website, for example).

The vendor subscription to marketplace server 102 may vary, according to various embodiments. In one example, there may be no cost to subscribe to marketplace server 102. In another example, there may be a cost to subscribe to marketplace server 102, and different costs of subscriptions may affect the level to which the vendor is given preferential treatment compared to other vendors.

Vendor account module 318 may further be configured to manage post-purchase activities. For example, upon the vendor selling an offer, vendor account module 318 may be configured to hold client funds in escrow for the vendor, may authorize the vendor for selling of the offer, may verify terms and conditions of the offer with the vendor, or otherwise. Post-purchase activities of the vendor and marketplace server 102 are described in greater detail with reference to FIG. 14.

Referring again to FIG. 3, memory 308 further includes feedback module 320. Feedback module 320 may manage client feedback provided by the client about the vendors. For example, upon completing interaction with a vendor (e.g., by either chatting with the vendor, purchasing an offer from the vendor, or otherwise interacting with the vendor in a bidding process or chatting process), the client may provide vendor feedback. The vendor feedback may relate to the quality of offers provided by the vendor, the quality of interaction with the vendor (e.g., friendliness), the relevancy of offers provided by the vendor, etc. The vendor feedback may also include if the vendor was previously cited for misusing the chat interface or bidding interface (if the vendor was identified as an offender by a filtering process of interactive chat module 312 or interactive bidding module 314). Feedback module 320 may receive and store the feedback. The feedback may be provided by the client by providing comments or by rating the vendors based on a numerical value or rating system.

Further, feedback module 320 may generate a vendor profile based on the feedback. The vendor profile may indicate to a client how friendly the vendor is, how often an offer is purchased from the vendor, the types of offers provided by the vendors, etc. Feedback module 320 may then provide the vendor profile to a client upon request, or may provide the vendor profile along with the search result relating to the vendor.

Referring generally to FIGS. 5-8, exemplary graphical user interfaces for the online marketplace system are shown, according to an exemplary embodiment. Referring more specifically to FIG. 5, a graphical user interface 500 for displaying search results is shown. In user interface 500 of FIG. 5, search results are shown to the client as a result of a search request from the client. The search results may be sorted by relevancy to the client as described above. In various embodiments, the search results may be sorted by search engine (e.g., search results found by the same search engine are grouped together), search results related to vendors subscribed to the marketplace server may be displayed at the top of the page, etc. For example, in FIG. 5, search results may first be sorted by the search engine that generated the search result (e.g., Bing, Yahoo, Google, etc.), and then by relevancy to the client or by vendor subscriptions to the online marketplace system. The search results may be repeated for each search engine (e.g., a search result retrieved by both Bing and Yahoo may be displayed once under each search engine) or the duplicate search results may be removed for one of the search engines.

An example search result 502 created by the online marketplace system of the present disclosure may include a description 504 for the search result. Description 504 may include a title, a small preview window, and general information about the search result. In addition, various links or buttons may be provided on user interface 500 to allow the client to interact with the marketplace server. For example, search result 502 includes a preview link 506. Upon selecting preview link 506, one or more preview images 508 for the website are displayed to the client as described with reference to website preview module 402.

Search result 502 further includes a chat link 510. Upon selecting chat link 510, a chat interface may be provided to the client and to a vendor. The chat interface is shown in greater detail in FIG. 6. The chat interface may be provided as a window on the current webpage, or the client may be taken to a new webpage. For example, upon selecting chat link 510, an alert may be provided to the corresponding vendor, and a chat window may be opened on the current webpage upon vendor acceptance. As another example, upon selecting chat link 510, the chat window may be provided instantly to the client, and the vendor may enter or exit the chat window at any time.

Search result 502 may optionally further include a bid link 512. Upon selecting bid link 512, a bidding interface may be provided to the client. The bidding interface is shown in greater detail in FIG. 7. The bidding interface may be selected by link 512 or may be selected from the chatting interface window, according to various embodiments. For example, the bidding interface may be activated from the chat interface, and link 512 may not be provided, in one embodiment.

User interface 500 may include one or more buttons, such as a checkbox 514, allowing the client to select one or more search results and vendors. This may allow the client to select multiple vendors to chat with or to start a bidding process with. For example, a client may select multiple search results via checkbox 514, then select a chat link 510 or another link or button on user interface 500 to open a chat interface that multiple vendors are invited to.

Referring to FIG. 6, the chat interface system is shown in greater detail. In the user interface 600 of FIG. 6, the client has selected a vendor to chat with. While user interface 600 illustrates a client chatting with one vendor, in other embodiments, the client may chat with more than one vendor (e.g., by chatting with multiple vendors in the same chat window or by opening one chat window for each vendor). In the embodiment of FIG. 6, chat interface 602 is shown as loaded on the same website as the search result; in other embodiments, another website may be used to display the chat interface. While chat interface 602 is shown as a new window on the same website, it should be understood that chat interface 602 may be any type of window or interface as described with reference to interactive chat module 312 of FIG. 3. For example, chat interface 602 may be embedded on the right or left side of user interface 600, chat interface 602 may be opened directly above, below, or next to the corresponding search result, chat interface 602 may only pop up on user interface 600 in any location once the vendor sends a message, etc.

In chat interface 602, a conversation is shown between a client and the vendor. The client may ask for information related to products and services offered by the vendor. Chat interface 602 may display the conversation. Chat interface 602 may further include one or more buttons that allow the client to initiate a bidding sequence (e.g., button 604 for asking the vendor to provide an offer) or to view vendor information or a vendor website (e.g., button 606).

Referring to FIG. 7, the bidding interface system is shown in greater detail. In the user interface 700 of FIG. 7, the client has selected to initiate a bidding process with one or more vendors. Bidding interface 702 is then provided to the client and all vendors the client wishes to include in the bidding process.

The client may start the bidding process, and vendors may provide offers to the client. The client may choose to accept or reject an offer. In one embodiment, links 704, 706 may be provided to the client in bidding interface 702 to accept and reject offers. In other embodiments, other buttons or links may be provided on the screen or bidding interface 702 to allow the client to accept or reject an offer. In yet other embodiments, the client may not be able to accept or reject offers, but may be able to talk to the vendors and select a vendor to chat with using chat interface 602. Upon selecting an offer to purchase from a vendor, the client may be taken to a website of the vendor or another website to complete the transaction.

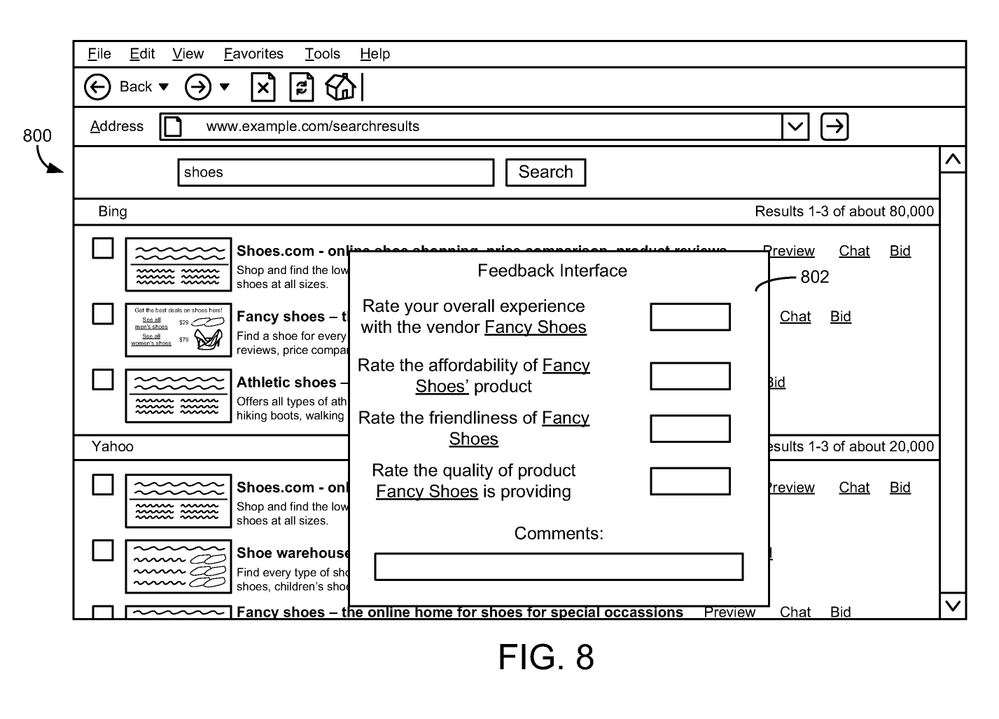

Referring to FIG. 8, the feedback system is shown in greater detail. Using user interface 800 of FIG. 8, the client may leave feedback related to the one or more vendors the client has interacted with (either via the chat interface or the bidding interface). Feedback interface 802 is provided to allow the client to provide feedback. Feedback interface 802 may be provided in a new window on the same webpage as the search results, or a new webpage may be loaded for the feedback interface.

Feedback interface 802 may allow the client to rate a vendor or product. The client may rate an overall experience with the vendor during the chatting and bidding process, may rate the quality and affordability of the products offered by the vendor, or may rate any other interaction with the vendor. Further, the client may leave comments about the vendor. Feedback interface 802 may receive the client input and provide the input to feedback module 320.

Using the feedback provided via feedback interface 802, the online marketplace system may be configured to allow a client to view the vendor feedback. For example, a link may be provided with search results for a vendor that when selected, allows the client to view vendor feedback (e.g., the vendor's rating, and selected comments about the vendor).

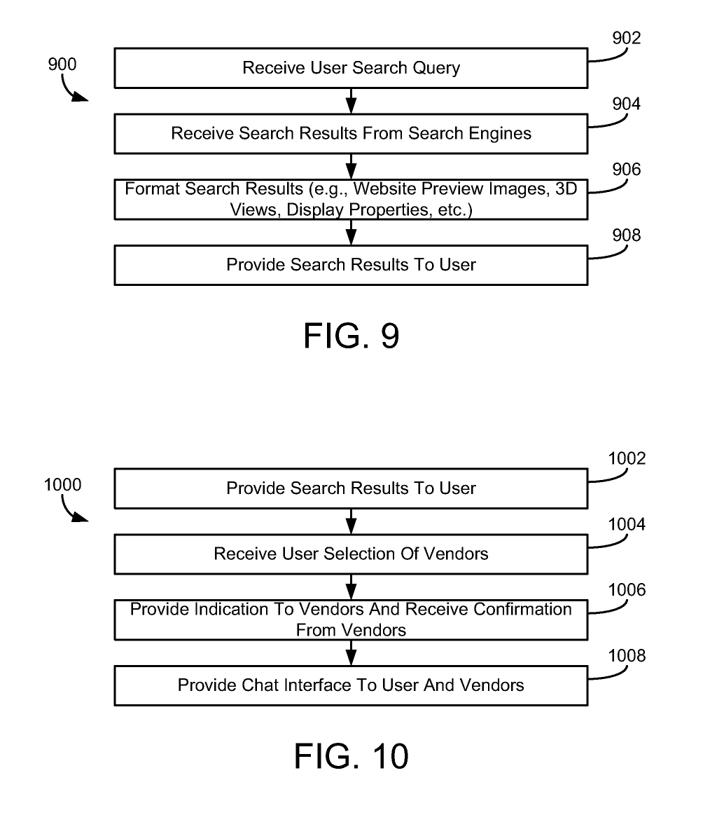

Referring now to FIG. 9, a flow chart of a process 900 for providing search results to a user of the online marketplace system is shown, according to an exemplary embodiment. Process 900 may be executed by, for example, a search engine module 310 of a marketplace server 102. Process 900 may be executed to provide search results to the user, allowing the user to select vendors associated with the search results for participation in a chat interface or bidding interface.

Process 900 includes receiving a user search query (step 902) and receiving the search results from search engines (step 904) related to the search query. The search results may then be formatted (step 906). The formatting of the search results may include generating website preview images, 3D views of the websites of the search results, determining display properties associated with the search results, reordering the search results based on vendor subscriptions and other information, and any other step as described with references to modules 402-408 of search engine module 310. Step 906 may further include providing a chat link or bid link with each search result, allowing the user to select a vendor to chat with or invite to a bidding process. The formatted search results are then provided to the user (step 908).

Referring now to FIG. 10, a flow chart of a process 1000 for providing a chat interface to a user and vendors of the online marketplace system is shown, according to an exemplary embodiment. Process 1000 may be executed by, for example, an interactive chat module 312 of a marketplace server 102.

Process 1000 includes providing search results to the user (step 1002). Process 1000 further includes receiving a user selection of one or more vendors (step 1004). The user may select vendors by clicking a link associated with a particular search result, by clicking on one or more checkboxes to select multiple vendors, etc. Process 1000 further includes providing an indication to the selected vendors and receiving confirmation from the vendors (step 1006). Step 1006 may generally entail alerting the vendors to user interest and receiving confirmation of vendor participation for chatting with the user. Process 1000 further includes providing the chat interface to the user and the selected vendors (step 1008). The user and vendor may then chat with each other using the chat interface. While in some embodiments or situations process 1000 may operate between a single client and vendor, in other embodiments or situations process 1000 may allow one or more clients access to the chat interface to chat with one or more vendors at the same time.

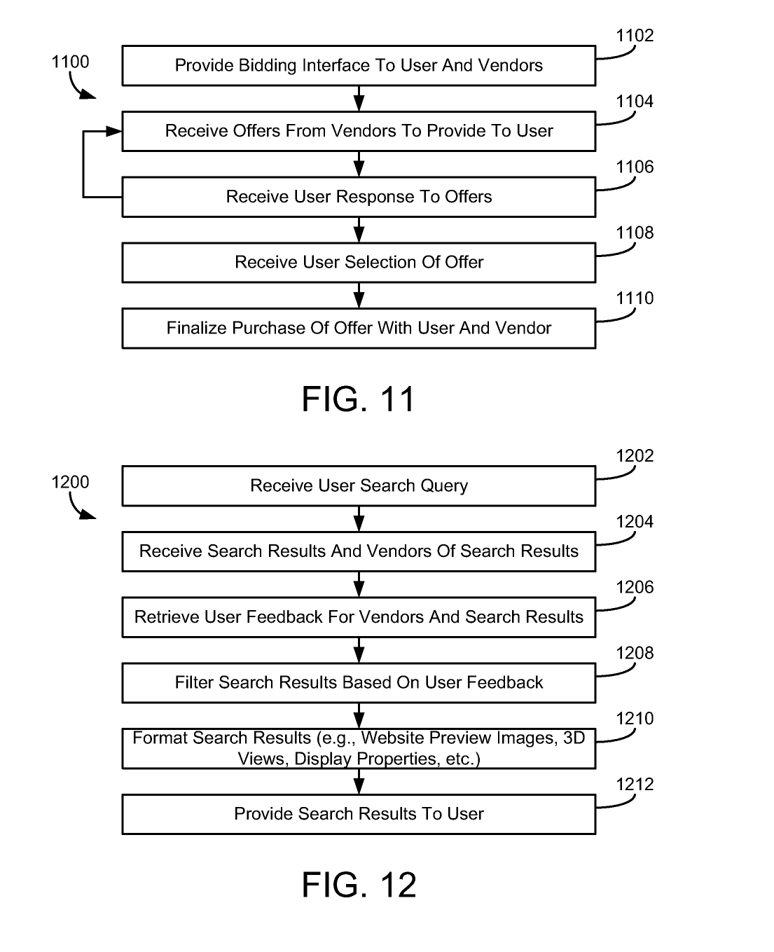

Referring now to FIG. 11, a flow chart of a process 1100 for providing a bidding interface to a user and vendors of the online marketplace system is shown, according to an exemplary embodiment. Process 1100 may be executed by, for example, an interactive bidding module 314 of a marketplace server 102.

Process 1100 includes providing a bidding interface to the user and vendors (step 1102). The bidding interface may be provided upon user request, according to one embodiment. The bidding interface is provided to the vendors that the user has selected. Process 1100 further includes receiving offers from the vendors to provide to the user (step 1104). Step 1104 may further include receiving other terms and comments related to the offers.

The user may receive the offers and may provide a response to the offers (step 1106). The response may be or include a rejection of an offer, an acceptance of an offer, or comments directed to the offers and/or vendors. If the user rejects the offers, the vendors may provide another offer or other comments to the user (step 1104).

When the user accepts an offer (step 1108), process 1100 further includes finalizing a purchase of the offer with the user and vendor (step 1110). Step 1110 may include verification of the purchase, or may simply include providing the user and vendor with an interface or another method of contact to complete the transaction. For example, after the user accepts an offer, the user and vendor may finalize the purchase independent of the marketplace server or using an interface of the marketplace server.

Referring now to FIG. 12, a flow chart of a process 1200 for providing search results to a user of the online marketplace system is shown, according to an exemplary embodiment. Process 1200 may include using user feedback to provide the search results. Process 1200 may be executed by, for example, a search engine module 310 and feedback module 320 of a marketplace server 102.

Process 1200 includes receiving a user search query (step 1202) and receiving search results and the vendors of the search results (step 1204). Process 1200 further includes retrieving user feedback for the vendors and search results (step 1206). User feedback may relate to the specific search result or the vendor.

Process 1200 further includes filtering the search results based on the user feedback (step 1208). For example, the search results and vendors associated with the search results with the best feedback may be presented at the top of the search results, while the search results and vendors associated with the search results with the worst feedback may be presented at the bottom of the search results or may not be presented at all.

Process 1200 further includes formatting the search results (step 1210) and providing the search results to the user (step 1212). Steps 1210-1212 may be similar to steps 906-908 of process 900 of FIG. 9.

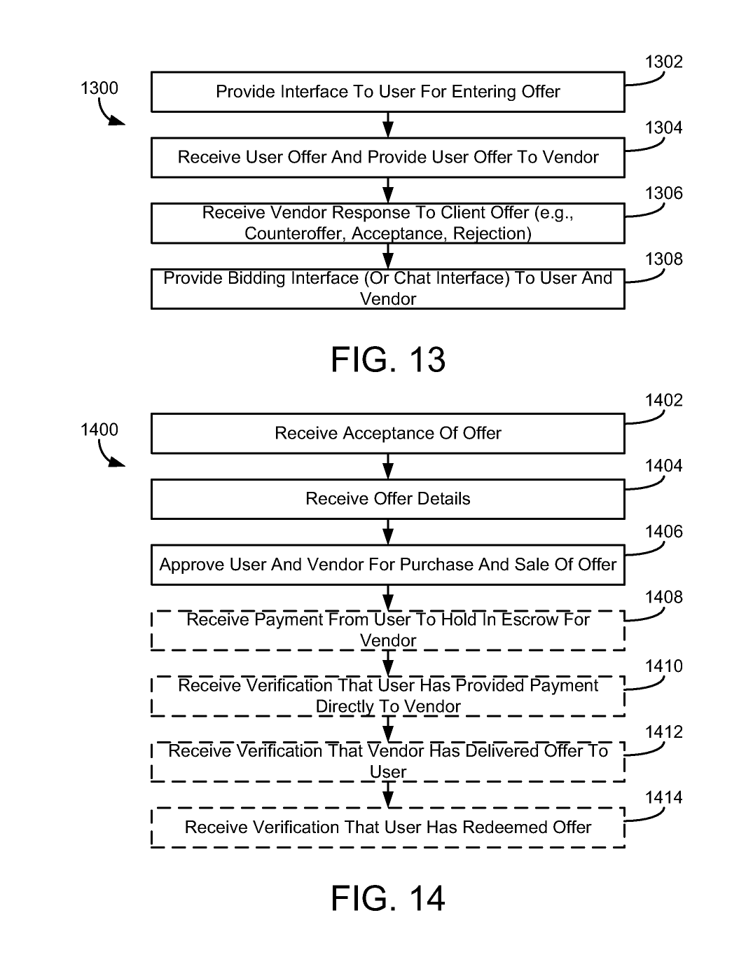

Referring now to FIG. 13, a flow chart of a process 1300 for providing a bidding interface in response to a user offer to a user and vendors of the online marketplace system is shown, according to an exemplary embodiment. Process 1300 may be executed to allow a user of the online marketplace system to select or bid on an offer for a product or service, and the vendor can respond to the user instead of the other way around.

Process 1300 includes providing an interface to the user for entering an offer (step 1302). For example, step 1302 may include providing a chat interface or bidding interface as described in the present disclosure, and the user may simply type in the offer. As another example, step 1304 may include providing an interface to the user that allows the user to select one or more vendor offers or one or more options related to the offers. For example, a list of offers may be provided to the user, and the user may select an offer and enter a bid for the offer. Further, options for the offer (e.g., for shoes, the shoe color may be an example of an option) may be selected by the user. The interface may be provided as part of a chat interface or bidding interface or as part of the search result (e.g., upon selection of a link of the search result, the offers and options may be chosen).

Process 1300 further includes receiving the user offer and providing the user offer to the vendor (step 1304). Process 1300 further includes receiving a vendor response to the client offer (step 1306). The vendor response may be an acceptance of the offer, a rejection of the offer, a counter-offer, or any other comment or reaction to the offer. Process 1300 further includes providing a bidding interface (or a chat interface) to the user and vendor (step 1308). The interface may allow the user and vendor to negotiate on the offer, finalize an acceptance or rejection of the offer, or to otherwise discuss the offer.

Referring now to FIG. 14, a flow chart of a process 1400 for offer authorization of the online marketplace system is shown, according to an exemplary embodiment. Process 1400 may be executed by the online marketplace system upon receiving an indication that a client and vendor have reached an agreement on an offer. Process 1400 may be used to authorize the purchase of the offer by the client and to otherwise manage the process of providing the payment to the vendor and the offer to the client.

Process 1400 includes receiving an acceptance of an offer (step 1402). The acceptance of the offer may be submitted through, for example, the bidding interface. Upon acceptance of the offer, the marketplace server may receive the offer details (step 1404). The offer details may include the product or service being sold, the price of the offer, a payment method for the offer, a delivery method for the offer (e.g., how the offer is to be redeemed or sent to the user), terms of the offer (e.g., refund details, offer insurance, or other terms or conditions for the usage of the services of the offer), and other offer information.

Process 1400 further includes approving the user and vendor for the purchase and sale of the offer (step 1406). Step 1406 may include verifying that the user has the funds available to purchase the offer. For example, the user may provide payment information to the marketplace server, and the marketplace server may approve the user. The marketplace server may process the payment itself or may simply verify the payment method and let the vendor handle the payment processing. In another embodiment, the marketplace server may open an escrow account for the user and hold the user funds, and then release the funds to the vendor at an appropriate time (e.g., upon delivery of the offer to the user). Step 1406 may further include verifying that the vendor has an available offer to provide to the user. For example, using vendor information from a vendor account module (e.g., module 318 of FIG. 4B), the marketplace server may verify that the vendor is able to provide the offer. Step 1406 may further include any verification process associated with any of the terms of the offer.

Process 1400 may further include various optional steps for authorizing the offer purchase upon user and vendor approval. For example, process 1400 may include receiving payment from the user to hold in escrow for the vendor (step 1408). As another example, process 1400 may include receiving verification that the user has provided payment directly to the vendor (step 1410). As yet another example, process 1400 may include receiving verification that the vendor has delivered the offer to the user (step 1412). As yet another example, process 1400 may include receiving verification that a user has redeemed an offer (step 1414). Any of the information received in steps 1108-1114 may be used by the marketplace server to verify that the offer purchase was completed without a problem to either the user or vendor. Process 1400 may further include determining if any of the verification steps that should have occurred have yet to occur, and if a message or warning should be provided to either the user or vendor about the missing verification steps. For example, if a user missed a payment, if the vendor did not provide the offer within a given time frame, or if the user or vendor violated a term or condition of the offer, the user and/or vendor may be notified.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

1. A computer-implemented method, comprising:
presenting, on a graphical user interface reporting search results for a product, information for a plurality of potential vendors of the product;
presenting, on the graphical user interface, an option to interact with each of a subset of the potential vendors; and
generating an interactive session between the user initiating the search and a selected vendor of the subset of the potential vendors.

2. The method of claim 1, wherein the interactive session is a chat session and is provided without requiring the user to browse away from the report of search results.

3. The method of claim 1, wherein the interactive session is a chat session and is provided in a window in the graphical user interface of reported search results.

4. The method of claim 1, wherein the interactive session is a chat session and is provided within a new pop-up window over the graphical user interface of reported search results.

5. The method of claim 1, further comprising:
recalling contact information for the vendor and establishing an on-demand communication link with a computing device of the vendor for conducting the interactive session.

6. The method of claim 5, wherein the on-demand nature of the communication link and the format of the vendor's computing device communication are normalized prior to presentation to the user in the interactive session.

7. The method of claim 1, wherein the option to interact is an option to chat and is presented as at least one of a link, a button, and a text box on the graphical user interface.

8. The method of claim 1, wherein the option to interact is an option to chat and is presented on the graphical user interface adjacent a graphical preview of the vendor's website.

9. The method of claim 1, further comprising:
presenting an option, on the graphical user interface reporting search results, for allowing simultaneous selection of more than one vendor for the interactive session; and
in response to the selection of the more than one vendor for the interactive session, causing the interactive session to be between the user and the more than one selected vendors in a single interactive session room.

10. The method of claim 1, wherein the interactive session is a text chat and wherein a link for purchasing the product from the vendor is caused to be shown in the text chat.

11. A computer system comprising:
a processor configured to cause the presentation, on a graphical user interface reporting search results for a product, information for a plurality of potential vendors of the product, wherein the processor is further configured to cause the graphical user interface to include an option to interact with each of a subset of the potential vendors, wherein the processor is configured to cause an interactive session to be generated, wherein the interactive session is generated between the user initiating the search and a selected vendor of the subset of the potential vendors.

12. The system of claim 11, wherein the processor provides the interactive session, wherein the interactive session is a chat session, wherein the chat session is provided without requiring the user to browse away from the report of search results.

13. The system of claim 11, wherein the interactive session is a chat session and is provided in a window in the graphical user interface of reported search results; and
wherein the graphical user interface is a web page.

14. The system of claim 11, wherein the interactive session is a chat session and is provided within a new pop-up window over the graphical user interface of reported search results.

15. The system of claim 11, wherein the processor is further configured to recall contact information for the vendor and to establish an on-demand communication link with a computing device of the vendor for conducting the interactive session.

16. The system of claim 11, wherein the on-demand nature of the communication link and the format of the vendor's computing device communication are normalized prior to presentation to the user in the interactive session.

17. The system of claim 11, wherein the option to interact is an option to chat and is presented as at least one of a link, a button, and a text box on the graphical user interface.

18. The system of claim 11, wherein the option to interact is an option to chat and is presented on the graphical user interface adjacent a graphical preview of the vendor's website.

19. The system of claim 11, wherein the processing circuit is further configured to present an option, on the graphical user interface reporting search results, for allowing simultaneous selection of more than one vendor for the interactive session; and in response to the selection of the more than one vendor for the interactive session, to cause the interactive session to be between the user and the more than one selected vendors in a single interactive session room.

20. The system of claim 11, wherein the interactive session is a text chat and wherein a link for purchasing the product from the vendor is caused to be shown in the text chat.

21. A non-transitory computer readable medium, comprising computer code for execution by a computer system including at least one processor, the computer code configuring the computer system to complete a process including:
receiving a search parameter relating to a product;
using the search parameter to generate a graphical user interface comprising a list of search results, the search results comprising links to a plurality of potential vendors of the product;
presenting, for at least a subset of the links to the plurality of potential vendors, an option for interacting with a representative from each vendor;
receiving user interface feedback representing a request to initiate an interactive session with a selected vendor; and
presenting an interactive session with the selected vendor in response to the received user interface feedback.

22. A non-transitory computer readable medium, comprising computer code for execution by a computer system including at least one processor, the computer code configuring the computer system to complete a process including:
receiving a search for a product from a first graphical user interface for operation by a consumer;
processing the search to identify vendors associated with offering the product;
soliciting bids from the vendors, the bids specifying the price at which the vendor would sell the product to a consumer;
presenting one or more of the bids to the consumer at a second graphical user interface; and
completing a sale between the consumer and the vendor using a bid selected by the consumer at the second graphical user interface.

23. The non-transitory computer readable medium of claim 22, wherein the receiving, processing, soliciting, presenting, and completing steps are caused to occur during a single log-in session of the consumer.

24. The non-transitory computer readable medium of claim 23, wherein the process further comprises:
presenting, on the second graphical user interface, the consumer with an option to conduct a live chat with the vendor submitting one of the bids.
